(19) United States
(12) Patent Application Publication
(10) Pub. No.: US 2010/0023517 A1
(43) Pub. Date: Jan. 28, 2010

(54) METHOD AND SYSTEM FOR EXTRACTING DATA-POINTS FROM A DATA FILE

(76) Inventors: Raja V., Saligramam (IN); Santhosh Narayanan, Bangalore (IN)

Correspondence Address: MICHAEL BEST & FRIEDRICH LLP, 100 E WISCONSIN AVENUE, Suite 3300, MILWAUKEE, WI, 53202, US

(21) Appl. No.: 12/510,296

(22) Filed: Jul. 28, 2009

(30) Foreign Application Priority Data
Jul. 28, 2008 (IN) 1801/CHE/2008

(51) Int. Cl. G06F 7/10; G06F 17/30

(52) U.S. Cl. 707/6; 707/E17.061; 707/E17.01; 707/E17.044; 707/E17.005

(57) ABSTRACT

The present invention provides a method, system and computer program product for extracting data-points from a data file. A data-point is extracted in a data-base by pointing at a portion of computer recognizable text in the data file by a pointing device. The data-point associated with the pointed portion of the computer recognizable text is thereby selected and stored in the database.

### BACKGROUND OF THE INVENTION

The present invention relates to extracting data-points from a data file. More specifically, it relates to extracting data-points from a data file to be imported to enterprising applications.

With advent of the Internet and outsourcing, various industries, such as banking, insurance, software, and so forth, maintain huge data associated with their customers. For example, a typical insurance company maintains relevant information, such as the name, the date of birth, the address, the policy number, and the like associated with each customer. The customers typically fill out such information corresponding to each of these fields in a form on paper. Thereafter, these companies update their database by copying the information from the paper forms associated with each customer in the respective fields of their enterprising applications.

Currently, the information associated with the fields is filled manually in the corresponding enterprising applications by users such as insurance agents. These agents generally receive the scanned image files of forms filled on paper. Thereafter, the agents copy the information corresponding to various fields manually from each scanned image file in the enterprising applications, i.e. manually typing the data-points corresponding to the fields. This may result in numerous errors such as, typographical errors, the relevant information filled into wrong fields, and so forth. Moreover, the manual entry process is time consuming and hence has proved to be less productive.

Further, recently, various software products have been made available in the market that provide a functionality of converting the scanned image file into a file that enables character recognition. The files are generated by using optical character recognition (OCR) algorithms. These files that are generated by OCR algorithms enable the agents to copy the information directly into the enterprising application in contrast to conventional manual feeding. The agents typically copy the information from the converted image file to the enterprising applications. Though it avoids manual typing of the information and is less time consuming, copying the information still lead to problems like, the relevant information entered into wrong fields, switching between various enterprising applications, and the like. Further, the agents copy the relevant information separately by using ‘copy’ and ‘paste’ while switching between various windows, thereby leading to a cumbersome process. These agents generally use a key-board or a pointing device, such as a mouse to ‘copy’ and ‘paste’ the relevant information thus resulting to either in multiple key strokes of the key-board or multiple clicks by the pointing device. Thus, this also proves to be a time consuming process. Further, such software products do not provide cost-effective solutions.

In light of the above, there is a need for a system and method that enables the agents to copy the information from the scanned images in lesser time. Further the system simultaneously should enable an error-free transfer of the information to the enterprising applications. Furthermore, the system should be cost-effective.

### SUMMARY OF THE INVENTION

An object the invention is to effectively transfer data-points to a database.

To achieve the objective mentioned above, the invention provides a method and a computer program product for extracting data-points from a data file. The data file contains computer recognizable text. The data file containing the computer recognizable text is displayed to a user through a user interface. A data-point is selected by pointing at a portion of the computer recognizable text associated with the data-point through a pointing device. Thereafter, the selected data-point is stored corresponding to a predefined field in a database.

Further, the invention provides a data capturing module for extracting data-points from a data file. The data capturing module includes a display module for displaying the data file containing computer recognizable text to a user through a user-interface. Thereafter, a portion of the computer recognizable text is pointed by the user by a pointing device. A selection module thereby selects a data-point associated with the pointed portion of the computer recognizable text. Subsequently, a storage module stores the data-point corresponding to a pre-defined field in a database.

The method, system and computer program product described above have a number of advantages. The method and system enables the user to extract the data-points from a data-file in an automated manner. This improves the speed at which the data-points are extracted from a data-file and exported to an enterprising application, thereby increasing the productivity of the user. Further, the system is cost-effective as it is developed using existing technologies/applications, such as Microsoft Office®, OCR algorithms, and so forth.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 illustrates an environment in which various embodiments of the invention may be practiced;

FIG. 2 is a block diagram of a data capturing module for extracting data-points from a data file, in accordance with an embodiment of the invention;

FIG. 3 is a block diagram of a data capturing module for extracting the data-points from the data file, in accordance with another embodiment of the invention;

FIG. 4 is a flowchart depicting a method for extracting data-points from a data file, in accordance with an embodiment of the invention; and

FIG. 5 is a flowchart depicting a method for extracting the data-points from the data file, in accordance with another embodiment of the invention.

### DETAILED DESCRIPTION

The invention describes a method, system and computer program product for extracting various data-points from a data file. The data-points are extracted in order to be exported to an enterprising application. The method and system enable the selection of the data-points. Further the method enables the storage of the selected data-points in a structured format in a database. Thereafter, the selected data-points are exported from the database to the enterprising application through one or more scripting tools.

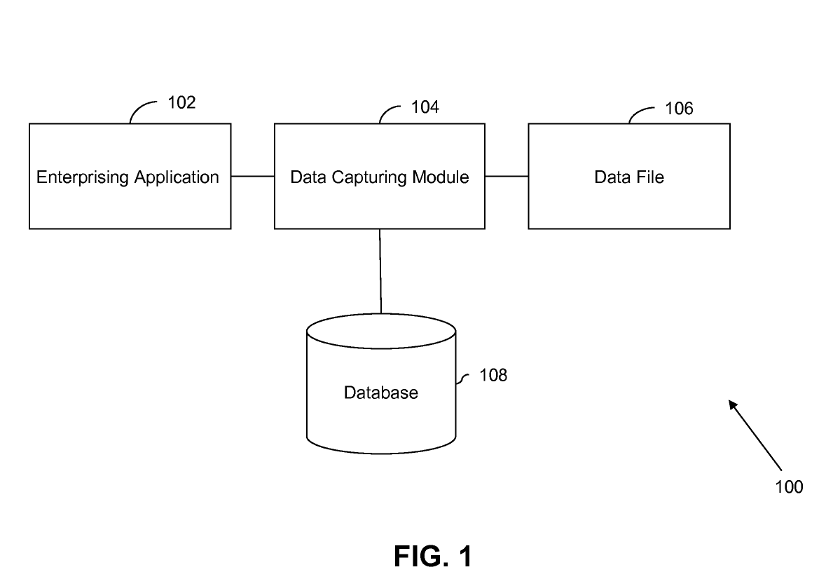

FIG. 1 illustrates an environment 100 in which various embodiments of the invention may be practiced. In various embodiments of the invention, environment 100 is a data processing unit, a network of data processing units, and the like. Various examples of the data processing units include personal computers, laptops, personal digital assistants (PDA), mobile devices, and the like. Further, environment 100 includes an enterprising application 102, a data capturing module 104, a data file 106, and a database 108.

Enterprising application 102 is a software application maintaining and processing various records pertaining to an enterprise. In an exemplary embodiment of the invention, these records can be pertaining to the customers of an organization. Various examples of enterprising application 102 include, but are not limited to, an application of an insurance service provider, an application managing the employees' information of a company, Enterprise Resource Planning (ERP) applications, and so forth. Further, enterprising application 102 include various fields like, ‘name of the customer’, and ‘insurance policy number of the customer’, ‘date of birth’, ‘mother's maiden name’, etc., associated with each customer for which the data is required from the users. Generally, the required data corresponding to the fields associated with each customer is present in an image file corresponding with each customer. Various examples of the image file can be a scanned document of an offer letter, an account statement, an insurance policy receipt, a screen shot of an application, a screen shot of a portion of an application, and the like.

Data capturing module 104 first converts the image file to data file 106. In other words, data capturing module 104 converts the content available in the image file to data file 106 containing computer recognizable text. It may be apparent to any person skilled in the art that the computer recognizable text can be copied from data file 106. In various embodiments of the invention, the computer recognizable text includes characters, numbers and symbols. In another embodiment of the invention, data file 106 may be generated from a file whose contents are computer recognizable. An example of such file may be Microsoft® Word document. Subsequently, data capturing module 104 displays data file 106 containing the computer recognizable text to a user through a user-interface.

Further, data capturing module 104 selects various data-points associated corresponding fields of enterprising application 102 from data file 106. In an embodiment of the invention, the user points at a portion of the computer recognizable text of the corresponding data-points associated with each field of enterprising application 102 using a pointing device. For example, the user points at a portion of the computer recognizable text associated with the corresponding name of the customer. Data capturing module 104 thereby stores the selected data-point corresponding to pre-defined field in a structured format in data base 108. Further, the pre-defined field is associated with the corresponding field of enterprising application 102. In another embodiment of the invention, the pre-defined field is defined by a user. Various examples of database 108 include but are not limited to, Microsoft® excel database, Microsoft® access database, and the like. In various embodiments of the invention, data capturing module 104 selects and stores the data-point simultaneously.

Furthermore, data capturing module 104 exports the stored data-points associated with the customer to the corresponding fields of enterprising application 102 by scripting tools. Various examples of the scripting tools include but are not limited to Visual Basic script, Shell scripts, JAVA scripts, Perl, Python, Rexx, Tcl, and so forth.

Similarly, data capturing module 104 stores various data points associated with multiple customers from various data files, such as data file 106, in database 108. Thereafter, data capturing module 104 exports the stored data-points associated with multiple customers to their corresponding fields in enterprising application 102.

In various embodiments of the invention, data capturing module 104 is configured to extract the data-points from various languages. In an embodiment of the invention, data capturing module 104 is developed using Microsoft® Technologies. Further, in accordance with various embodiment of the invention, the pointing device is a mouse communicatively coupled to environment 100.

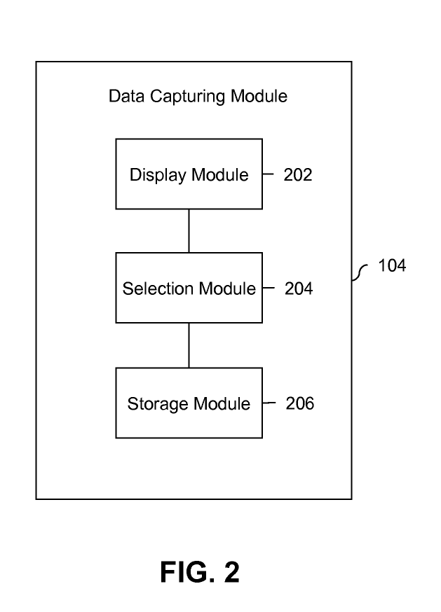

FIG. 2 is a block diagram depicting data capturing module 104 for extracting data-points from data file 106, in accordance with an embodiment of the invention. Data capturing module 104 includes a display module 202, a selection module 204 and a storage module 206.

Display module 202 displays data file 106 containing computer recognizable text to a user through a user-interface. As explained earlier in FIG. 1, there are various data-points available in data file 106. The user points at a portion of the computer recognizable text associated with a data-point, which he wishes to select, by a pointing device. There are various ways in which the user can point at the computer recognizable text. In an embodiment of the invention, the user may place the cursor on the computer recognizable text associated with the data-point. For example, if the user wishes to select ‘James’ from data file 106, he may place the cursor on any letter of the word, such as before ‘a’ of ‘James’. In another embodiment of the invention, the user can mark a boundary by the pointing device around a portion of the computer recognizable text associated with the data-point. For example, if the user wishes to select ‘James Hetfield’ as the data-point, he may mark a boundary around ‘mes Het’ of ‘James Hetfield’. Further, the user can also mark a boundary around ‘James Hetfield’ in order to select ‘James Hetfield’ as the data-point.

Thereby selection module 204 selects the data-point associated with the portion of the computer recognizable text pointed by the pointing device. In various embodiments of the invention, selection module 204 identifies the existing text between the first preceding and the first succeeding blank spaces from the pointed portion of the computer recognizable text. This identified text is selected as the data-point by selection module 204.

In the above stated examples, selection module 204 identifies the first preceding and the first succeeding blank spaces from ‘a’ and selects ‘James’ as the data-point. Similarly, selection module 204 identifies the text existing between the first preceding and the first succeeding blank spaces from ‘mes Het’ and selects the identified text, i.e. ‘James Hetfield’ as the data-point.

Subsequently, storage module 206 stores the selected data-point corresponding to the pre-defined field in database 108. For example, ‘James’ will be stored corresponding to ‘Name’ in database 108. In other words, ‘James’ is selected and subsequently stored corresponding to the field ‘Name’ in database 108 by pointing at the portion of the computer recognizable text, i.e., ‘James’ is selected and stored in the same stroke of the pointing device. Similarly, storage module 206 stores various data-points from data file 106 corresponding to the pre-defined fields in database 108. In another embodiment of the invention, storage module stores various data-points from multiple data files, such as data file 106, corresponding to pre-defined fields in database 108.

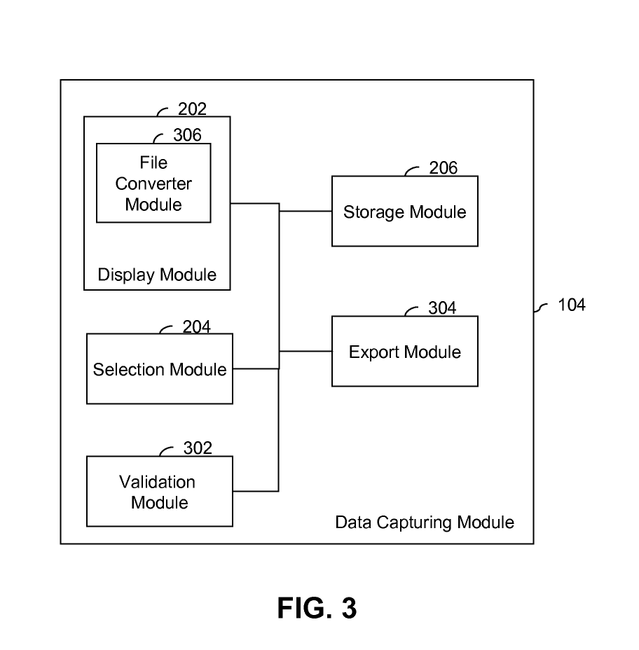

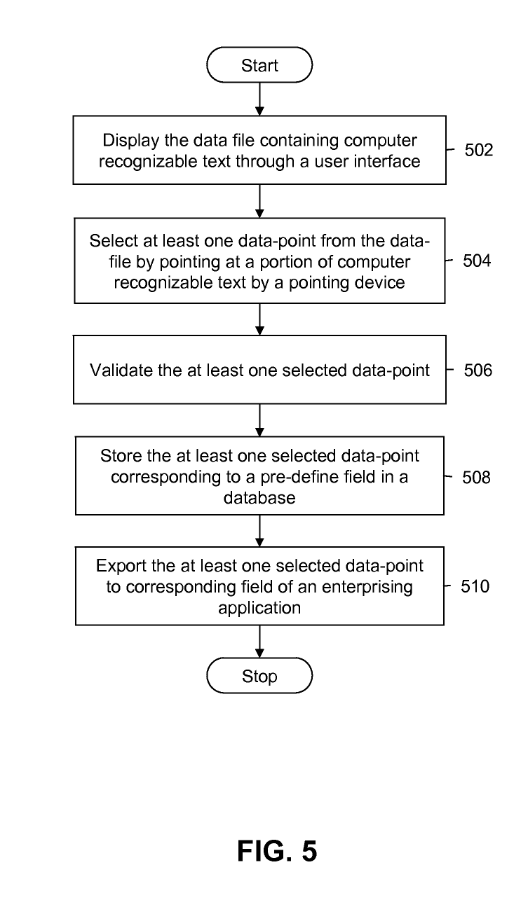

In an embodiment of the invention, the stored data-points thereafter are exported to enterprising application 102. Exporting of the stored data-points is explained in detail in conjunction with FIG. 3 and FIG. 5.

FIG. 3 is a block diagram of data capturing module 104 for extracting the data-points from data file 106, in accordance with another embodiment of the invention. Data capturing module 104 includes display module 202, selection module 204, storage module 206, a validation module 302 and an export module 304. Further, display module 202 includes a file converter module 306.

Display module 202 displays data file 106 containing the computer recognizable text to a user through a user-interface. Data file 106 displayed to the user is generated from an image file. In various embodiments of the invention, the image file contains the information that is required to be exported to enterprising applications, such as enterprising application 102. For example, the image file can be an image of a receipt of insurance policy of a customer. Further, various examples of formats of the image file include but are not limited to, a Tagged Image File Format (TIFF) file, a Jay Peg (JPG) file, a bitmap (BMP) file, and so forth.

File converter module 306 converts the content of the image file to data file 106 containing the computer recognizable text. In an embodiment of the invention, file converter module 306 converts the image file stored in the local memory of a computer to data file 106. In another embodiment of the invention, file converter module 306 converts the screen shot taken with the help of ‘print screen’ functionality of an operating system to data file 106. In yet another embodiment, the content of any portion of the screen can be converted to data file 106. In an embodiment of the invention, file converter module 306 uses Microsoft® Office Document Imaging (MODI) software to convert the image file to data file 106 in MODI format. It may be apparent to any person skilled in the art that MODI software executes one or more optical character recognition (OCR) algorithms to convert the content of the image file to computer recognizable text.

In another embodiment of the invention, file converter module 306 converts the image file to data file 106 each time prior to displaying to the user. Subsequently, display module 202 displays data file 106 to the user through the user interface.

Thereafter, as explained in FIG. 2 the user can point at a portion of the computer recognizable text associated with the required data-point. Subsequently, selection module 204 selects the data-point associated with the pointed portion of the computer recognizable text from data file 106. Selection of the data-point from data file 106 has been explained in detail in conjunction with FIG. 2.

This selected data-point is displayed to the user by validation module 302 through the user-interface. Validation module 302 enables the user to edit and validate the selected data-point. In an embodiment of the invention, the user might validate the data-point after editing. For example, if the selected data-point is ‘James’ and the user wishes to edit it to ‘James H’ based on the format required by a pre-defined field in database 108, then the user is allowed to edit the selected data-point through validation module 302. Similarly, if the data-point selected by selection module 204 is erroneous, such as Jame, instead of the original name ‘James’, then validation module 302 facilitates the user to edit the text accordingly. In another embodiment of the invention, the user might validate the data directly when he decides not to edit the data-point. For example, if the selected data-point, ‘James’, is error-free, then the user will directly validate the data-point. In various embodiments of the invention, the user validates the data-point by clicking on the data-point using the pointing device. Further, various ways of clicking can be pre-set by the user.

Subsequently, after the selected data-point is validated, storage module 206 stores the selected data-point to the pre-defined filed in data base 108. Similarly, storage module 206 stores various data-points corresponding to the pre-defined fields in database 108. The functionalities of storage module 206 have been further explained in detail in conjunction with FIG. 2.

Export module 304 exports the stored data-points to the corresponding fields of Enterprising application 102. The fields of enterprising application 102 are associated with the pre-defined fields of database 108. For example, if an insurance company X wishes to update their records by adding a new customer ‘James’, then the data point, such as, ‘James Hetfield’ stored corresponding to the predefined filed, ‘name of the customer’, is exported to corresponding the field of enterprising application 102. In an embodiment of the invention, export module 304 executes scripting tools in order to export the stored data-points to enterprising application 102.

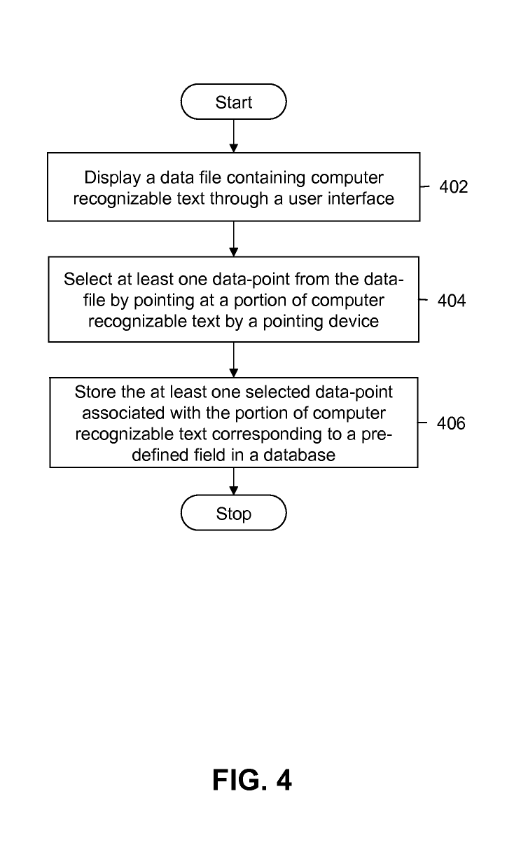

FIG. 4 is a flowchart of a method for extracting data-points from a data file, such as data file 106, in accordance with an embodiment of the invention. In various embodiments of the invention, the data file contains computer recognizable text.

At 402, the data file containing the computer recognizable text is displayed to a user though a user-interface.

Thereafter, at 404, the user points at a portion of the computer recognizable text in the data-file by a pointing device. There are various ways that the user can point at the computer recognizable text. In an embodiment of the invention, the user may place the cursor on the computer recognizable text associated with a data-point. For example, if the user wishes to select ‘James’ from the data file, he may place the cursor on any letter of the word, such as, after ‘a’ of ‘James’. In another embodiment of the invention, the user can mark a boundary by pointing device around a portion of the computer recognizable text associated with the data-point. For example, if the user wishes to select ‘James Hetfield’ as the data-point, then the user marks a boundary around ‘mes Het’ of ‘James Hetfield’. Further, the user also might mark a boundary around ‘James Hetfield’ in order to select ‘James Hetfield’ as the data-point.

Subsequently, the data-point associated with the pointed portion of the computer recognizable text is selected. In various embodiments of the invention, the existing text between the first preceding and the first succeeding blank spaces from the pointed portion of the computer recognizable text is identified. The identified text is selected as the data-point. In above mentioned examples, ‘James’ and ‘James Hetfield’ are selected as the respective data-points.

The selected data-point is stored corresponding to a pre-defined field in a database at 406. In an embodiment of the invention, the pre-defined field is associated with a corresponding field of an enterprising application. Further, various examples of the database include but are not limited to, Microsoft® excel database, Microsoft® access database, and the like. It may be apparent to any person skilled in the art that, the selection and storage of the data-point is performed by pointing at the portion of the computer recognizable text. In other words, the selection and storage is performed in a single stroke of the pointing device. Similarly, various data-points from the data file are stored corresponding to pre-defined fields in the database. In another embodiment of the invention, various data-points from multiple data files can be stored corresponding to pre-defined fields in the database.

Thereafter, the stored data-points can be exported to the corresponding fields of the enterprising application. Exporting of the stored data-points is explained in detail in conjunction with FIG. 3 and FIG. 5.

FIG. 5 is a flowchart depicting a method for extracting the data-points from the data file, in accordance with another embodiment of the invention.

As described above in FIG. 4, at 502, the data file is displayed to a user through a user-interface. In an embodiment of the invention, the data file containing computer recognizable text is generated by conversion of the content present in an image file. Various examples of the image file can be a scanned document, a screen shot of an application, a screenshot of any portion of the application and so forth. Further, various examples of format of the image file include but are not limited to, a Tagged Image File Format (TIFF) file, a (Jay Peg) JPG file, a bitmap (BMP) file, and so forth.

In an embodiment of the invention, the image file is converted to the data file by Microsoft® Office Document Imaging software. Further, MODI software executes one or more optical recognition (OCR) algorithms to convert the contents of the image file to computer recognizable text.

At 504, the user points at a portion of the computer recognizable text by a pointing device. Thereafter, the data-point associated with the computer recognizable text is selected. Selection of the data-point by pointing at the portion of the computer recognizable text has been explained in detail in conjunction with FIG. 2 and FIG. 4.

At 506, the selected data-point is validated by the user. In an embodiment of the invention, the user can validate the data-point after editing the selected data-point. For example, if the selected data-point is ‘James’, then the user can edit the selected data-point, such as ‘James H’. In another embodiment of the invention, the user can validate the data without editing the selected data-point. For example, if the selected data-point, ‘James’, is error-free, then the user will directly validate the data-point. In various embodiments the user completes the validation by clicking the pointing device. Further, various ways of clicking can be preset by the user.

At 508, the data-point selected after the validation is stored corresponding to a pre-defined field in a database. In an embodiment of the invention, the selected data-point is stored in the database by clicking on the selected data-point by the pointing device after the validation is performed by the user. For example, ‘James H’ is stored corresponding to the pre-defined field, ‘name of the customer’. In another embodiment of the invention, the data-point is stored after the selection of the data-point by pointing at the portion of the computer recognizable text when the data-point is not provided for validation. In other words the data-point associated with the pointed portion of the computer recognizable text is selected and stored in a single stroke of the pointing device. Further, as explained earlier in FIG. 4, multiple data-points are stored corresponding to respective pre-defined fields in the database.

At 510, the stored data-points are exported to the corresponding fields of an enterprising application. As per the above example, ‘James H’ is exported to the corresponding field in the enterprising application. In an embodiment of the invention, scripting tools are used to export the stored various data-points to the corresponding fields of the enterprising application. Various examples of the scripting tools include but are not limited to, Visual Basic script, Shell scripts, JAVA scripts, Perl, Python, Rexx, Tcl, and so forth.

The method, system and computer program product described above have a number of advantages. The method and system enables the user to extract data-points from data-files in an automated manner. This improves the speed, accuracy of the extraction of the data-points. Further, the method enables an efficient transfer of the stored data-points to an enterprising application. The method and system also convert the image file to a data file for ease in selection of the data-points. This data file is not stored in the local memory of the data processing unit, thereby decreasing the memory consumption. Further, the system is cost-effective as it is developed using existing technologies such as Microsoft® technologies, OCR algorithms, and so forth.

The method and system for extracting data-points from a data file in a database, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for extracting one or more data-points from a data file, the one or more data-points being extracted in a database, the one or more data-points suitable for being exported to an enterprising application, the data file comprising computer recognizable text, the data point corresponding to a pre-defined field in the database, the pre-defined field being associated with a field of the enterprising application, the method comprising:
a. displaying the data file to a user through a user-interface;
b. selecting at least one of the one or more data-points from the data file, the at least one data-point being selected by pointing on a portion of the computer recognizable text by a pointing device, the portion of the computer recognizable text being associated with the at least one data-point, the pointing device being controlled by the user; and
c. storing the at least one selected data-point corresponding to the pre-defined field in the database, wherein the at least one selected data-point is stored by pointing on the portion of the computer recognizable text in the data file.

2. The method according to claim 1 further comprising exporting the at least one stored data-point from the database to the corresponding field of the enterprising application, wherein the export of the at least one stored data-point facilitates the functioning of the enterprising application.

3. The method according to claim 1 further comprising validating the at least one selected data-point through the user-interface, wherein the at least one selected data-point is validated by the user before the data-point is stored in the database.

4. The method according to claim 3, wherein validating the at least one selected data-point further comprises editing the at least one data-point, the editing being performed by the user.

5. The method according to claim 1, wherein the computer recognizable text comprises at least one of characters, numbers and symbols.

6. The method according to claim 1, wherein the portion of the computer recognizable text is pointed by clicking by the pointing device.

7. The method according to claim 1, wherein the portion of the computer recognizable text is pointed by marking a boundary around the portion of the computer recognizable text, the boundary being marked by the user by the pointing device.

8. The method according to claim 1, wherein selecting the at least one data-point from the data file comprises identifying the existing text between the first preceding and the first succeeding blank spaces of the pointed portion of the computer recognizable text, the identified existing text being selected as the at least one data-point.

9. The method according to claim 1, wherein the data file is generated from an image file, the image file being converted to the data file by one or more optical character recognition algorithms.

10. The method according to claim 1, wherein the at least one data-point is from one or more languages.

11. A data capturing module extracting one or more data-points from a data file, the one or more data-points being extracted in a database, the one or more data-points suitable for being exported to an enterprising application, the data file comprising computer recognizable text, the data point corresponding to a pre-defined field in the database, the pre-defined field being associated with a field of the enterprising application, the data capturing module comprising:
a. a display module configured for displaying the data file to a user through a user-interface;
b. a selection module configured for selecting at least one of the one or more data-points from the data file, wherein the at least one data-point is selected based on a portion of the computer recognizable text pointed by a pointing device, the portion of the computer recognizable text being associated with the at least one data-point, the pointing device being controlled by the user; and
c. a storage module configured for storing the at least one selected data-point corresponding to the pre-defined field in the database, wherein the at least one selected data-point is stored based on the portion of the computer recognizable text pointed by the pointing device in the data file.

12. The data capturing module according to claim 11 further comprises a export module configured for exporting the at least one stored data-point from the database to the corresponding field of the enterprising application.

13. The data capturing module according to claim 11 further comprises a validation module configured for enabling the user to validate the at least one selected data-point through the user-interface.

14. The data capturing module according to claim 13, wherein the validation module is further configured to enable the user to edit the at least one data-point.

15. The data capturing module according to claim 11, wherein the portion of the computer recognizable text is pointed by clicking by the pointing device.

16. The data capturing module according to claim 11, wherein the portion of the computer recognizable text is pointed by marking a boundary around the portion of the computer recognizable text, the boundary being marked by the user by the pointing device.

17. The data capturing module according to claim 11, wherein the selection module selects the at least one data-point from the data file by identifying the existing text between the first preceding and the first succeeding blank spaces of the pointed portion of the computer recognizable text.

18. The data capturing module according to claim 11, wherein the display module further comprises a file converter module configured for generating the data file from an image file, the image file being converted to the data file through one or more optical character recognition algorithms.

19. The data capturing module according to claim 11, wherein the at least one data-point is from one or more languages.

20. A computer program product for use with a computer, the computer program product comprising a computer usable medium having a computer readable program code embodied therein for extracting one or more data-points from a data file, the one or more data-points being extracted in a database, the one or more data-points suitable for being exported to an enterprising application, the data file comprising computer recognizable text, the data point corresponding to a pre-defined field in the database, the pre-defined field being associated with a field of the enterprising application, the computer readable code performing:
a. displaying the data file to a user through a user-interface;
b. selecting the at least one of the one more data-points from the data file, the at least one data-point being selected by pointing on a portion of the computer recognizable text by a pointing device, the portion of the computer recognizable text being associated with the at least one data-point, the pointing device being controlled by the user; and
c. storing the at least one selected data-point corresponding to the pre-defined field in the database, wherein the at least one selected data-point is stored by pointing on the portion of the computer recognizable text in the data file.

21. The computer program product according to claim 20, wherein the computer readable code further performs exporting the at least one stored data-point from the database to the corresponding field of the enterprising application, wherein the export of the at least one stored data-point facilitates the functioning of the enterprising application.

22. The computer program product according to claim 20, wherein the computer readable code further performs validating the at least one selected data-point through the user-interface, wherein the at least one selected data-point is validated by the user before the data-point is stored in the database.

23. The computer program product according to claim 22, wherein validating the at least one selected data-point further comprises editing the at least one data-point, the editing being performed by the user.

24. The computer program product according to claim 20, wherein the portion of the computer recognizable text is pointed by clicking by the pointing device.

25. The computer program product according to claim 20, wherein the portion of the computer recognizable text is pointed by marking a boundary around the portion of the computer recognizable text, the boundary being marked by the user by the pointing device.

26. The computer program product according to claim 20, wherein selecting the at least one data-point from the data file comprises identifying the existing text between the first preceding and the first succeeding blank spaces of the pointed portion of the computer recognizable text, the identified existing text being selected as the at least one data-point.

27. The computer program product according to claim 20, wherein the data file is generated from an image file, the image file being converted to the data file by one or more optical character recognition algorithms.

28. The computer program product according to claim 20, wherein the at least one data-point is from one or more languages.
